(19) United States
(12) Patent Application Publication
(10) Pub. No.: US 2023/0136507 A1
(43) Pub. Date: May 4, 2023

(54) HYBRID MODEL FOR CASE COMPLEXITY CLASSIFICATION

(71) Applicant: Hewlett Packard Enterprise Development LP, Houston, TX (US)

(72) Inventors: Ravi Ranjan Prasad Karn, Bangalore (IN); Naveen Chenoli, Bangalore (IN)

(21) Appl. No.: 17/513,647

(22) Filed: Oct. 28, 2021

(51) Int. Cl. G06N 20/10; G06K 9/62

(52) U.S. Cl. CPC G06N 20/10; G06K 9/6281; G06K 9/6269

(57) ABSTRACT

Examples relate to a hybrid model for case complexity classification. In an example, a set of fields corresponding to a case is received and the set of fields are inputted to a hybrid model comprising a set of rules and a predictive model. The predictive model includes a predictive machine learning model trained using a historical set of cases that are specific to a technical domain of the case. A case complexity classification for the case is determined via the hybrid model and based on analysis of the set of fields using the set of rules and the predictive model. The case complexity classification is utilized to route the case for processing.

### BACKGROUND

Many businesses and organizations maintain service centers or other operations that provide technical support for the products, services, and other offerings provided by the business and/or organization. Such technical support centers can provide feedback, opinions, information or data, troubleshooting, updates, repairs, and/or other technical support to customers in a variety of formats. A customer may contact the technical support center via a variety of communication interfaces in one or more different formats (e.g., phone, email, online, electronic messaging, etc.). The customer's issue may be assigned a case in the technical support center. When addressing the case in the technical support center, the technical support center seeks to reduce a resolution time of the case and mitigate any duplication of technical support work.

### BRIEF DESCRIPTION OF THE DRAWINGS

Implementations described here are illustrated by way of example, and not by way of limitation, in the figures of the accompanying drawings in which like reference numerals refer to similar elements.

FIG. 1 illustrates an example of a system employing a data center.

FIG. 2 illustrates a data center environment including an infrastructure manager providing for dynamic optimizations of server and network layers according to some implementations.

FIG. 3 is a block diagram of a data center environment implementing dynamic optimizations of server and network layers according to some implementations.

FIG. 4 is an example packet header of a datacenter environment that is analyzed for dynamic optimizations of server and network layers according to some implementations.

FIG. 5 illustrates operations for dynamic optimizations of server and network layers according to some implementations.

FIG. 6 illustrates operations for another process for dynamic optimizations of server and network layers according to some implementations.

### DETAILED DESCRIPTION

Implementations described herein are directed to facilitating a hybrid model for case complexity classification. Many businesses and organizations maintain service centers or other operations that provide technical support for the products, services, and other offerings provided by the business and/or organization. Such technical support centers can provide troubleshooting, updates, repairs, feedback, opinions, information or data, and/or other technical support to customers in a variety of formats. The customer's issue may be assigned a case in the technical support center. When addressing the case in the technical support center, the technical support center seeks to reduce a resolution time of the case and mitigate any duplication of technical support work.

In a conventional technical support environment, all cases arrive at a lower skill level of support (e.g., a “Level 1”) and then move up (“escalate”) to higher skill levels of support (e.g., “Level 2”, “Level 3”, and so on) based on the complexity of the issue in the case. As used herein, complexity may refer to a level of difficulty in understanding or resolving a problem, a state of intricacy of the problem, and/or how complicated the problem is. Complexity can be distinguished from a severity of the case, where the severity may refer to an urgency of the case (e.g., a case may have a high level of complexity, but a low severity). Complexity can also be distinguished from an entitlement associated with the case, which may refer to a pre-determined level of support assigned to the case irrespective of the complexity of the underlying problem of the case.

A highly-complex case may utilize engineering or development support to address the underlying problem. The automation of case routing to such engineering or development support is a difficult task. When the case is created, it has to be routed to the right team and it is also expected that the case is routed to the right set of people within the team who can solve the problem. In conventional technical support environments, the case may arrive first at a Level 1 engineer, then escalate to a Level 2 engineer, and then finally escalate to a Level 3 engineer that can diagnose and address the problem. At each level, a considerable amount of time is spent for diagnosis and troubleshooting before the case is escalated to the next level. Moreover, the complexity of the underlying problem may be exacerbated for highly technical products, such as data center hardware and software infrastructure (e.g., servers, storage appliances, networking equipment, etc.), and the result time spent for diagnosis and troubleshooting is additionally increased in such cases. Because of the limited resources available for the highly-skilled support levels (e.g., Level 3 engineer) and the high cost associated with the highly-skilled support levels, not all cases can be assigned to these levels directly from the outset of case intake. Overall resolution time of the cases would increase in such situations, leading to customer dissatisfaction and escalations.

However, if case complexity could be identified early on in case intake, such high complexity cases could be moved to the appropriate levels at the outset, skipping the intermediate levels and, thus, saving time and improving efficiency. Similarly, a low complexity case that can be resolved by the least skilled engineer could be identified at the outset and assigned to the appropriate technical support resources (e.g., appropriate support level). Early identification of complexity can allow for cases to be assigned to the appropriate technical support level resources quickly and efficiently.

In implementations herein, a technical support environment is provided that facilitates a hybrid model for case complexity classification. The technical support environment of implementations herein dynamically determines case complexity classifications using a hybrid machine learning engine that implements a rules-based analysis in conjunction with a predictive model. When a new case arrives for technical support in a case management system of the technical support environment, a set of fields corresponding to the case (e.g., subject field, issue text field, severity field) are provided to the case complexity classification system for analysis. The case complexity classification system first applies a set of rules to the fields to identify if there is a match. The set of rules may identify, for example, an error code, an event signature, text string, or other keywords indicative of a technical issue associated with the case.

If there is a match to the set of rules, the matching rule is applied and a corresponding case complexity is output from the rule and assigned to the case. If there is not a match to the set of rules, the set of fields are vectorized and passed as input to a trained predictive model. The predictive model then outputs a case complexity to assign to the case. Once the case complexity is determined by the case complexity classification system, a case complexity field in the case management system is updated with the corresponding case complexity for the case. This case complexity field is utilized for routing the case to an appropriate technical support level (e.g., an engineer, etc.) assigned to handle cases having the associated case complexity classification.

In implementations herein, the predictive model used by the case complexity classification system can be trained using domain-specific (i.e., technical domain) historical case data, where each case (in the set of historical case data) is labelled for case complexity by a domain expert (e.g., an engineer, administrator, etc.). These cases are processed using natural language processing techniques for training purposes. A machine learning algorithm, such as a support vector machine (SVM) with linear kernel and 12 regularization, can be applied to train the predictive model used by the case complexity classification system.

Implementations provide a technical effect of reducing the resolution time of a case, resulting in improved performance of the technical support system. The domain-specific training of the hybrid model described herein additionally takes into account additional subject-matter complexity that may be involved in a highly-technical domain area, and thus improves automated case routing and reduces time to resolve the case. Furthermore, implementations described herein reduce duplication of technical support work, resulting in reduced power consumption, improved utilization of resources, and improved latency and bandwidth of the server and network components of the technical support environment.

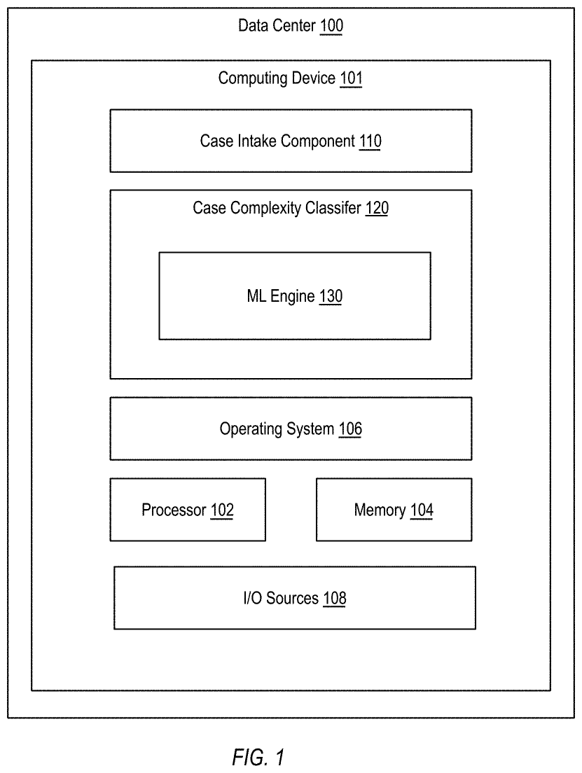

FIG. 1 illustrates an implementation of a data center 100. As shown in FIG. 1, data center 100 includes one or more computing devices 101 that may be server computers serving as a host for data center 100. In implementations, computing device 101 may include (without limitation) server computers (e.g., cloud server computers, etc.), desktop computers, cluster-based computers, set-top boxes (e.g., Internet-based cable television set-top boxes, etc.), etc. Although a single computing device 101 is illustrated in FIG. 1, implementations herein may utilize one or more computing devices 101 to provide for and host the hybrid model for case complexity classification described herein. Computing device 101 includes an operating system (“OS”) 106 serving as an interface between one or more hardware/physical resources of computing device 101 and one or more client devices, not shown. Computing device 101 further includes processor(s) 102, memory 104, input/output (“I/O”) sources 108, such as touchscreens, touch panels, touch pads, virtual or regular keyboards, virtual or regular mice, etc.

In an implementation, computing device 101 includes a server computer that may be further in communication with one or more databases or storage repositories, which may be located locally or remotely over one or more networks (e.g., cloud network, Internet, proximity network, intranet, Internet of Things (“IoT”), Cloud of Things (“CoT”), etc.). Computing device 101 may be in communication with any number and type of other computing devices via one or more networks.

According to an implementation, computing device 101 implements a case intake component 110 to receive and process new cases for technical support in the data center 100. In an implementation, case intake component 110 is implemented via one or more logic circuits such as, for example, hardware processors including processor 102. In some examples, case intake component 110 may be implemented by hardware, software, firmware and/or any combination of hardware, software and/or firmware. Case intake component 110 may receive one or more cases for technical support. In an implementation, the cases may be associated with a user (e.g., a customer) seeking technical support for one or more products. The cases may have corresponding case details (e.g., documentation), such as a case identifier (ID), username, user contact information, product, subject, issue text, severity, and so on. The case details may each stored in corresponding fields for the case in a data store (e.g., stored in memory 104).

In an implementation, a separate computing device (e.g., associated with a separate service) may be responsible for interfacing with the user to receive the case and corresponding case details, and cause the case details to be stored in the case data store. Case intake component 110 may communicate with the separate computing device to determine when a new case(s) is created and cause the case details to be passed to the case complexity classifier 120.

In an implementation, the computing device 101 (or one or more computing devices 101) implements a case complexity classifier 120. In an implementation, case complexity classifier 120 is implemented via one or more logic circuits such as, for example, hardware processors including processor 102. In some examples, case complexity classifier 120 may be implemented by hardware, software, firmware and/or any combination of hardware, software and/or firmware. Case complexity classifier 120 can communicate with case intake component 110 and manage case complexity classification across a datacenter environment of data center 100. In an implementation, case complexity classifier may be implemented by a same hardware component (e.g., a same logic circuit) or by different hardware components (e.g., different logic circuits, different computing systems, etc.) as case intake component 110.

Case complexity classifier 120 may include a machine learning (ML) engine 130. In implementations herein, ML engine 130 may be implemented by hardware, software, firmware and/or any combination of hardware, software and/or firmware. In implementations herein, the case complexity classifier 120 utilizes the ML engine 130 to determine the complexity of a case or an incident at different stages of the life cycle of the case based on the case details of the case. ML engine 130 provides a hybrid system that uses a combination of rule-based functions and statistical predictive modeling to determine a case complexity classification.

In an implementation, the ML engine 130 may perform ML-based training and inference as part of the hybrid system. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a neural network is used. Using a neural network enables classification of objects in images, natural language processing, etc. In general, machine learning models/architectures that are suitable to use in the example approaches disclosed herein may include neural networks (NNs). However, other types of machine learning models could additionally or alternatively be used such as recurrent neural network, feedforward neural network, etc.

In general, implementing an AI/ML system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of AI/ML model and/or the expected output. For example, supervised training uses inputs and corresponding expected (e.g., labeled) outputs to select parameters (e.g., by iterating over combinations of select parameters) for the AI/ML model that reduce model error. As used herein, labelling refers to an expected output of the machine learning model (e.g., a classification, an expected output value, etc.) Alternatively, unsupervised training (e.g., clustering, principal component analysis, etc.) involves inferring patterns from inputs to select parameters for the AI/ML model (e.g., without the benefit of expected (e.g., labeled) outputs).

Referring back to ML engine 130, the ML engine 103 may provide for a training phase and an inference phase (e.g., classification). In some implementations, the training phase of ML engine 130 may be performed in a different computing device 101 than the computing device 101 performing the inference phase. In some implementations, the training phase and inference phase may be performed by the same computing device 101.

In one example, in a training phase, the ML engine 130 can collect historical case data. In an implementation, a balanced sample of cases is derived. These cases are then labelled for their complexity by domain experts (e.g., administrators, engineers, technicians, etc.). The ML engine 130 processes the labelled historical case data using, for example, natural language processing techniques and creates a vectorizer and corpus. The ML engine 130 then applies one or more ML techniques to train a predictive model.

In implementations herein, the ML engine 130 also acquires one or more rules that define a complexity of a case from the domain experts. The ML engine 130 then incorporates the set of rules with the trained predictive model. When the case complexity of a new case is to be determined, the case complexity classifier 120 first applies the set of rules at ML engine 130 to determine whether a case complexity can be identified for the new case. If there is no matching rule found, then the case complexity classifier 120 uses the ML engine 130 to process unlabeled data from the new case and vectorize this data using the same processing and vectorization subsystem used while training the predictive model. The vectorized data is then passed through the trained predictive model to determine the case complexity for the new case.

In an implementation, the hybrid system to determine case complexity can be configured to be domain specific (e.g., rules and trained predictive models are generated for specific technical domains), which may perform better on specific domain data than a generic (e.g., one size fits all) system. The hybrid system to determine case complexity can also use domain-specific stop words (i.e., from the vocabulary of the specific domain) in conjugation with generic stop words. The hybrid system to determine case complexity also provides for multilingual support (e.g., set of rules and trained predictive model are based on data provided in one or more languages).

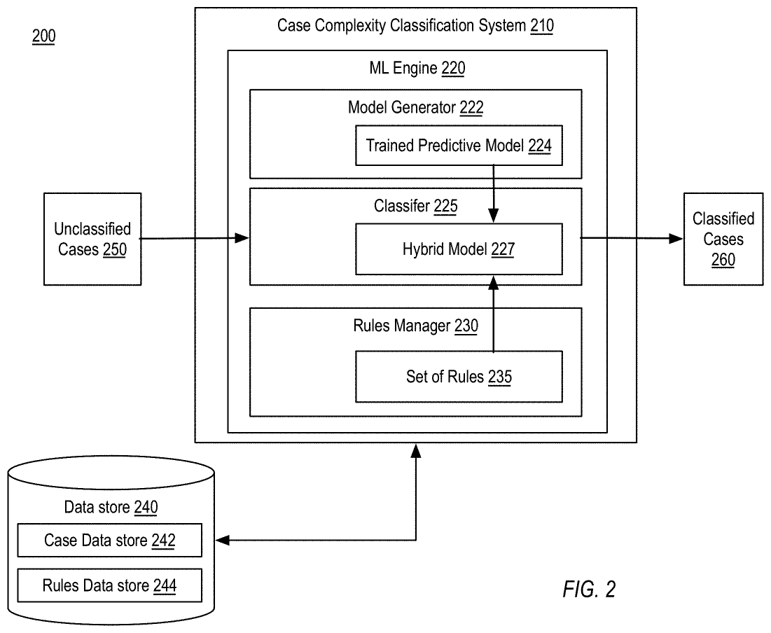

Further details of the operations of case complexity classifier 120, including ML engine 130, are described further below with respect to FIGS. 2-6.

FIG. 2 illustrates a data center environment 200 including a case complexity classification system 210 providing a hybrid model, such as a machine learning model, for case complexity classification, according to some implementations. In an implementation, case complexity classification system 210 is similar in many respects to case complexity classifier 120 described with respect to FIG. 1. In implementations herein, case complexity classification system 210 may be implemented as hardware (e.g., a processor, circuitry, dedicated logic, programmable logic, etc.) or a combination of hardware and software (such as instructions run on a processing device). Case complexity classification system 210 may be implemented on one or more computing devices. For example, training of the hybrid model may be provided a computing device that is different than a computing device implementing the trained hybrid model.

As shown in FIG. 2, case complexity classification system 210 of data center environment 200 includes an ML engine 220 having a model generator 222, a classifier 225, and a rules manager 230. The example ML engine 220 of FIG. 2 may be similar to ML engine 130 described with respect to FIG. 1. In an implementation, ML engine 220 may include one or more elements, processes and/or devices in addition to, or instead of, those illustrated in FIG. 2, and/or may include more than one of any or all of the illustrated elements, processes, and devices.

In implementations of the disclosure, the case complexity classification system 210 operates to determine the case complexity of a new case (e.g., unclassified cases 250) and hence route the new case (e.g., as classified case 260) to a corresponding level of technical support (e.g., engineer, etc.) that is capable of resolving the issue(s) associated with the new case.

For purposes of the discussion below, one example of case complexity classifications may be implemented as shown below in Table 1. However, other case complexity classification systems may be implemented by implementations herein, and are not limited to the example shown in Table 1.

TABLE 1

| Complexity | Description | Technical Support Level |
|---|---|---|
| C1 | Low complexity | Level 1 |
| C2 | Medium complexity | Level 2 |
| C3 | High complexity | Level 3 |

As previously noted, an unclassified case 250 may have case details including, but not limited to, subject, issue text, severity, product, and so on. Based on these case details, the case complexity classification system 210 can identify the complexity of the case. In implementations herein, the subject and issue text can be in the English language, but they can also be in other languages, such as German, French, Japanese, etc.

The hybrid model discussed herein can refer to a combination rule-based and prediction-based model. With respect to the rules-based portion of the hybrid model, the rules can be defined by domain experts (e.g., engineers, administrators, etc.) who have in-depth knowledge in the specific case resolution domain. In an implementation, a corpus of rules for multiple technical domains (e.g., servers, storage, networking, etc.) may be stored in the rules data store 244 of data store 240, which can be accessed by the rules manager 230. The rules manager 230 may identify the set of rules 235 from the rules data store 244 for the specific technical domain, and apply that set of rules 235 to a new case (e.g., unclassified case 250) that is to be classified in that specific technical domain.

Some example sample rules are shown in Table 2 below. However, other sets of rules may be implemented by implementations herein, and are not limited to the example shown in Table 2.

TABLE 2

| Rule | Complexity |
|---|---|
| Error code 1 found in subject of case | C1 (Low complexity) |
| Error code 2 found in subject of case | C2 (Medium complexity) |
| Error code 3 found in subject of case | C3 (High complexity) |
| Signature 1 found in subject of case | C2 (Medium complexity) |
| Signature 2 found in subject of case | C3 (High complexity) |
| Keyword/Key phrase 1 found in issue text | C1 (Low complexity) |
| of case | |
| Keyword/Key phrase 2 found in issue text | C3 (high complexity) |
| of case | |

With respect to the prediction-based model portion of the hybrid model, a trained predictive model 224 can be created for utilization in performing case complexity classification by the hybrid model 227. In an implementation, the model generator 222 of the ML engine 220 can generate the trained predictive model 224 using Natural Language Processing (NLP) and/or classification techniques of machine learning. In one example, the model generator 222 may access historical case data from a case data store 242 of data store 240. The historical case data may include, but is not limited to, subject and issue text provided in a text format for multiple past technical support cases processed by the case complexity classification system 201 and/or other technical support systems. In some implementations, the historical case data may be provided as a training data set by another organization. Using the subject and issued text in the text format of the historical case data, the model generator 222 can perform text processing to identify the features that can be used as input for the training performed by the model generator 222.

In one example, the following text processing steps can be applied by the model generator 222:

1. Remove unwanted junk characters keeping the error codes from the text (subject and issue text);

2. Remove punctuation;

3. Tokenization, including sentences tokenization and/or word tokenization;

4. Term frequency and inverse document frequency (TF-IDF) vectorization with n-gram=3 (or n-gram=2 or n-gram=1).

In some implementations, to accommodate the classification of the cases where subject and issue text are in different languages, the words from other languages are not removed while cleaning the data (in steps 1 and 2). Vocabulary of the terms specific to the domain is used as part of determining which terms to keep and remove. The TF-IDF vectorization described above (in step 4) calculates the score, which is the ratio of frequency of term (e.g., words, bi-gram of words, and tri-gram of words) and the log of the ratio of total number of cases (documents in NLP terminology) and number of cases in which that term is found.

In one example, a mathematical representation of TD-IDF in logarithmic scale may be provided as follows:

For a term t in document d, where document d∈document−setD;

TF-IDF:

Tf−idf(t,d,D)=tf(t,d).idf(t,D)

Where TF:

tf(t;d)=log(1+freq(t;d))

and IDF:

idf(t,D)=log((1+N)/(1+count(d∈D:t∈d)))

In an implementation, the case details may include a severity (e.g., urgency) field provided in a text format. In this case, the model generator 222 may apply text encoding to this severity field text to convert the severity text into features and the values as zeros and ones. As a result, the terms with their TF-IDF score and severity can be used by model generator 222 for training a classification model (i.e., trained predictive model 224). The features are extracted and their values are converted into numerical data. This data can then be utilized for training the machine learning model. Any of a variety of machine learning algorithms and hyper-parameters can be applied to create the trained predictive model 224. In an implementation, the model generator 222 utilizes a Support Vector Machine (SVM) with linear Kernel and 12 regularization to generate the trained predictive model 224.

When a new case arrives at case complexity classification system 210 as an unclassified case 250, the case is passed to the classifier 225 of the ML engine 220. The classifier 225 determines the trained predictive model 224 and the set of rules 235 to apply to the case based on the technical domain of the case. In an example, the technical domain of the case can be determined based on the case details data in the set of fields of the case. Once the trained predictive model 224 and set of rules 235 are identified and provided as hybrid model 227, the classifier 225 applies the hybrid model 227 to perform a lookup in the set of rules 235.

The classifier 225 first determines whether the new case generates a match with any of the set of rules 235. If there is a corresponding rule found, the complexity of the case is determined from the matched rule 235. If there is no associated rule, then the classifier 225 applies the hybrid model 227 to perform text processing of the subject and issue text. In an implementation, a TF-IDF vectorizer, such as described above, is applied to identify the features and the score for each feature. This data is passed to trained predictive model 224 of the hybrid model 227, which then determines the complexity of the case. In an implementation, the determined case complexity score output by the hybrid model 227 is then provided as a case complexity field for the new case, which is routed in the data center environment 200 as a classified case 260.

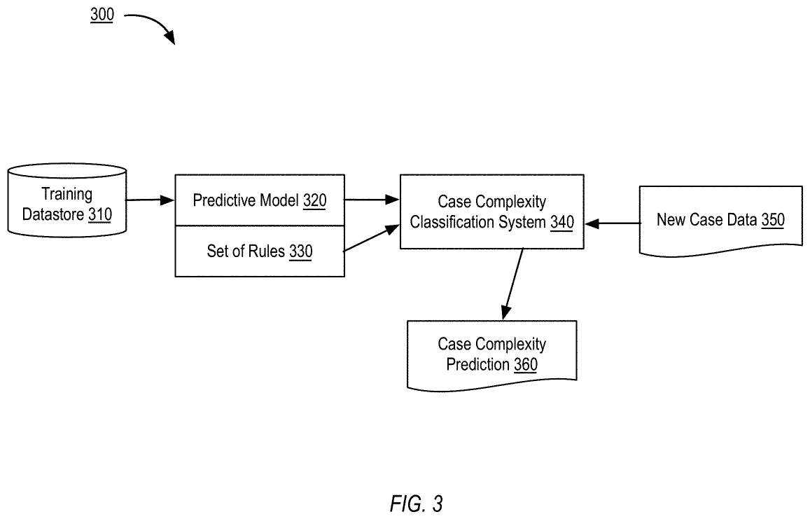

FIG. 3 is a schematic of a technical support environment 300 implementing a hybrid model for case complexity classification, according to some implementations. Technical support environment 300 depicts an example flow of configuring and applying a hybrid model for case complexity classification in the technical support environment 300 of implementations of the disclosure. In an implementation, the technical support environment 300 of FIG. 3 includes a case complexity classification system 340 receiving a variety of inputs and generating an output as part of case complexity classification as described herein. In an implementation, the case complexity classification system 340 may be similar to case complexity classifier 120 described with respect to FIG. 1 and/or case complexity classification system 210 described with respect to FIG. 2.

In implementations herein, the technical support environment 300 dynamically determines case complexity classifications using a hybrid model at the case complexity classification system 340. The hybrid model utilizes a predictive model 320 in conjunction with a set of rules 330. In an implementation, the predictive model 320 may be similar to the trained predictive model 224 described with respect to FIG. 2 and the set of rules 330 may be similar to the set of rules 235 described with respect to FIG. 2. The training data store 310 may be store historical case data that is used to train the predictive model 320.

In some implementations, the predictive model 320 used by the case complexity classification system 340 can be trained using domain-specific (i.e., technical domain) historical case data, where each case (in the set of historical case data) is labeled for case complexity by a domain expert. These cases are processed using natural language processing techniques and vectorized for training purposes. A machine learning algorithm, such as a support vector machine (SVM) with linear kernel and 12 regularization, is applied to train the predictive model 320 used by the case complexity classification system 340.

When a new case having new case data 350 arrives for technical support in the technical support environment 300, the case is provided to the case complexity classification system 340 for case complexity classification. The new case data 350 may include a set of fields corresponding to the case (e.g., subject field, issue text field, severity field) and is provided to the case complexity classification system 340 for analysis. Based on the set of fields in the new case data 350, the case complexity classification system 340 first applies the set of rules 330 to the set of fields to identify if there is a match. The set of rules 330 may identify, for example, an error code, an event signature, text string, or other keywords indicative of a particular technical issue associated with the case. If there is a match to the set of rules 330, the case complexity classification system 340 applies the matching rule and outputs a corresponding case complexity prediction 360 for assignment to the case.

If there is not a match to the set of rules 330 (e.g., failing to identify a keyword match), the set of fields from the new case data 350 are vectorized and passed as input to the trained predictive model 320. The case complexity classification system 340 then outputs, based on the application of the predictive model 320, a case complexity prediction 360 to assign to the case.

In an implementation, once the case complexity prediction 360 is determined by the case complexity classification system 340, a case complexity field in a case management system (not shown) of the technical support environment 300 is updated with the corresponding case complexity for the case. This case complexity field can be utilized for routing (e.g., processing) the case to an appropriate technical support level (e.g., engineer, etc.) assigned to handle cases having the associated case complexity value.

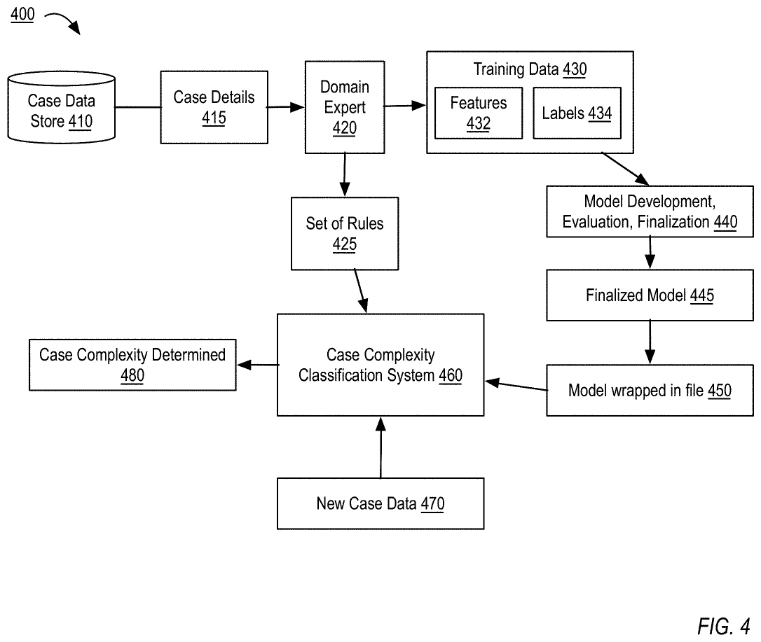

FIG. 4 is another schematic of a technical support environment 300 implementing a hybrid model for case complexity classification, according to some implementations. The schematic of FIG. 4 illustrates one example implementation of a hybrid model for case complexity classification that may be implemented by implementations herein, and is not intended to be limiting to the disclosure.

In implementations herein, the technical support environment 400 facilitates the hybrid machine learning model for case complexity classification as described herein. The technical support environment 400 dynamically determines case complexity classifications using a hybrid machine learning model. The hybrid machine learning model utilizes a predictive model 445 in conjunction with a set of rules 425.

In an implementation, the predictive model 445 may be similar to the trained predictive model 224 described with respect to FIG. 2 and/or predictive model 320 described with respect to FIG. 3. In an implementation, the set of rules 425 may be similar to the set of rules 235 described with respect to FIG. 2 and/or the set of rules 330 described with respect to FIG. 3.

In an implementation, a domain expert 420 may access case details 415 from historical case data in a case data store 410 to generate the set of rules 425, as well as generate training data 430 from the case details 415 including features 432 and associated labels 434. These case details 415 can be processed using natural language processing techniques and vectorized to generate the training data 430. The training data 430 may be used for model development, evaluation, and finalization 440 to generate the final trained predictive model 445. A machine learning algorithm, such as a support vector machine (SVM) with linear kernel and 12 regularization, may be applied to train the predictive model 445.

The finalized predictive model 445 may be wrapped in a file 450 and passed to the case complexity classification system 460. The model wrapped in the file 450 may be used in conjunction with the set of rules 425 at the case complexity classification system 460 as a hybrid machine learning model for case complexity classification. In an implementation, the case complexity classification system 460 may be similar to the case complexity classifier 120 described with respect to FIG. 1, case complexity classification system 210 described with respect to FIG. 2, and/or case complexity classification system 340 described with respect to FIG. 3.

When a new case having new case data 470 arrives for technical support in the technical support environment 400, the case is provided to the case complexity classification system 460 for case complexity classification. The new case data 470 may include a set of fields corresponding to the case (e.g., subject field, issue text field, severity field) and is provided to the case complexity classification system 460 for analysis. Based on the set of fields in the new case data 470, the case complexity classification system 460 first applies the set of 425 to the set of fields to identify if there is a match. The set of rules 425 may identify, for example, an error code, an event signature, text string, or other keywords indicative of a particular technical issue associated with the case. If there is a match to the set of rules 425, the case complexity classification system 460 applies the matching rule and outputs a corresponding case complexity determination 480 for assignment to the case.

If there is not a match to the set of rules 425, the set of fields from the new case data 470 are vectorized and passed as input for processing by the trained predictive model 450. The case complexity classification system 460 then outputs, based on the application of the predictive model 450, a case complexity determination 480 to assign to the case.

In an implementation, once the case complexity determination 480 is generated by the case complexity classification system 460, a case complexity field in a case management system (not shown) of the technical support environment 400 is updated with the corresponding case complexity for the case. This case complexity field can be utilized for routing the case to an appropriate technical support level (e.g., engineer, etc.) assigned to handle cases having the associated case complexity value.

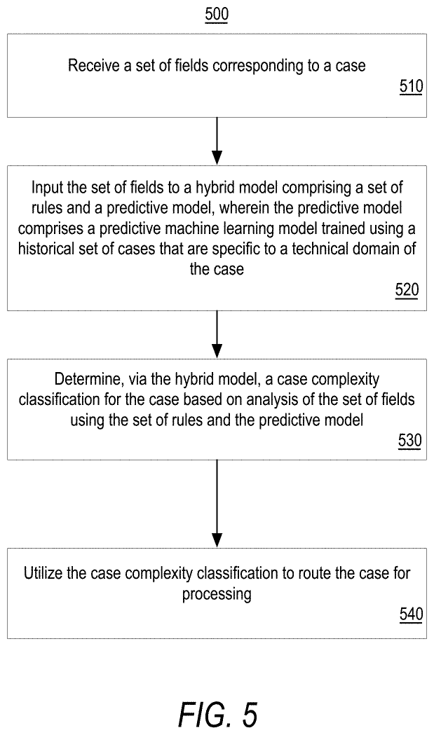

FIG. 5 is a flow chart to illustrate a process 500 for implementing a hybrid model for case complexity classification in some implementations. Process 500 may be performed by processing logic that may comprise hardware (e.g., a processor, circuitry, dedicated logic, programmable logic, etc.) or a combination of hardware and software (such as instructions run on a processing device). In an implementation, the process 500 may be performed by any of, for example, case complexity classifier 120 described with respect to FIG. 1, case complexity classification system 210 of FIG. 2, case complexity classification system 340, and/or case complexity classification system 460 of FIG. 4. In some implementations, a process 500 to provide for implementing a hybrid model for case complexity classification includes the following:

At block 510, a processing device, such as one executing a case complexity classification system, may receive a set of fields corresponding to a case. At block 520, the processing device may input the set of fields to a hybrid model comprising a set of rules and a predictive model. In an implementation, the predictive model can include a predictive machine learning model trained using a historical set of cases that are specific to a technical domain of the case.

Subsequently, at block 530, the processing device may determine, via the hybrid model, a case complexity classification for the case based on analysis of the set of fields using the set of rules and the predictive model. Lastly, at block 540, the processing device may utilize the case complexity classification to route the case for technical support processing.

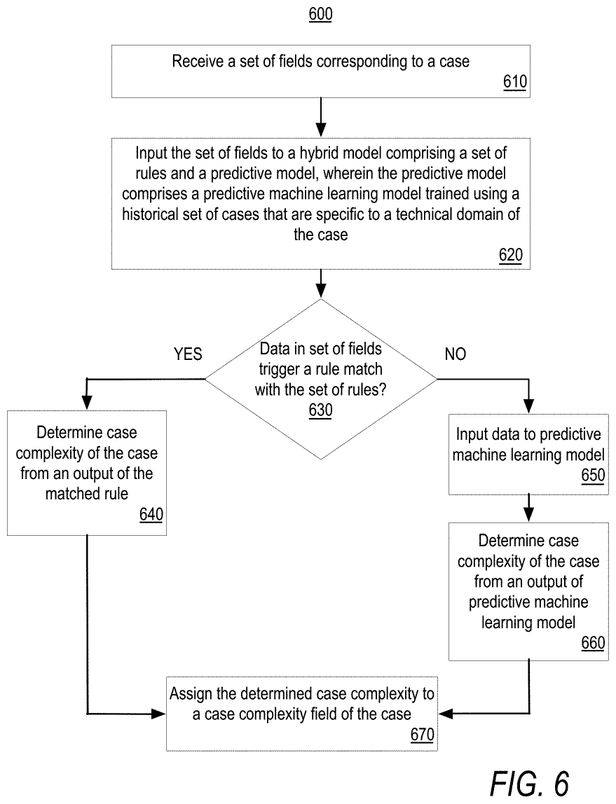

FIG. 6 is a flow chart to illustrate a process 600 for implementing a hybrid model using a set of rules and a predictive model for case complexity classification in some implementations. Process 600 may be performed by processing logic that may comprise hardware (e.g., a processor, circuitry, dedicated logic, programmable logic, etc.) or a combination of hardware and software (such as instructions run on a processing device). In an implementation, the process 600 may be performed by any of, for example, case complexity classifier 120 described with respect to FIG. 1, case complexity classification system 210 of FIG. 2, case complexity classification system 340, and/or case complexity classification system 460 of FIG. 4. In some implementations, a process 600 to provide for implementing a hybrid model using a set of rules and a predictive model for case complexity classification includes the following:

At block 610, a processing device, such as one executing a case complexity classification system, may receive a set of fields corresponding to a case. At block 620, the processing device may input the set of fields to a hybrid model comprising a set of rules and a predictive model. In an implementation, the predictive model can include a predictive machine learning model trained using a historical set of cases that are specific to a technical domain of the case.

Then, at decision block 630, the processing device may determine whether data in the set of fields triggers a rule match with the set of rules. If so, process 600 proceeds to block 640 where the processing device may determine a case complexity of the case from an output of the matched rule.

On the other hand, if the data in the set of fields does not trigger a rule match with the set of rules (e.g., failing to identify a keyword match), process 600 proceeds to block 650. At block 650, the processing device may input data to a predictive machine learning model. Then, at block 660, the processing device may determine case complexity of the case from an output of predictive machine learning model. Lastly, from both of block 640 and 660, process 600 proceeds to block 670, where the processing device may assign the determined case complexity to a case complexity field of the case.

Implementations may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

The following clauses and/or examples pertain to further implementations or examples. Specifics in the examples may be applied anywhere in one or more implementations. The various features of the different implementations or examples may be variously combined with certain features included and others excluded to suit a variety of different applications. Examples may include subject matter such as a method, means for performing acts of the method, at least one machine-readable medium (or machine-readable storage medium), such as a non-transitory machine-readable medium or a non-transitory machine-readable storage medium, including instructions that, when performed by a machine, cause the machine to perform acts of the method, or of an apparatus or system for facilitating operations according to implementations and examples described herein.

In some implementations, an apparatus for facilitating a hybrid model for case complexity classification includes a processor, and a machine readable storage medium storing instructions for a case complexity classifier that, when executed by the processor, cause the processor to: receive a set of fields corresponding to a case; input the set of fields to a hybrid model comprising a set of rules and a predictive model, wherein the predictive model comprises a predictive machine learning model trained using a historical set of cases that are specific to a technical domain of the case; determine, via the hybrid model, a case complexity classification for the case based on analysis of the set of fields using the set of rules and the predictive model; and utilize the case complexity classification to route the case for processing.

In some implementations, a non-transitory machine-readable storage medium encoded with instructions that, when executed by a hardware processor, cause the hardware processor to receive a set of fields corresponding to a case; input the set of fields to a hybrid model comprising a set of rules and a predictive model, wherein the predictive model comprises a predictive machine learning model trained using a historical set of cases that are specific to a technical domain of the case; determine, via the hybrid model, a case complexity classification for the case based on analysis of the set of fields using the set of rules and the predictive model; and utilize the case complexity classification to route the case for processing.

In some implementations, a method for facilitating a hybrid model for case complexity classification includes receiving a set of fields corresponding to a case; inputting the set of fields to a hybrid model comprising a set of rules and a predictive model, wherein the predictive model comprises a predictive machine learning model trained using a historical set of cases that are specific to a technical domain of the case; determining, via the hybrid model, a case complexity classification for the case based on analysis of the set of fields using the set of rules and the predictive model; and utilizing the case complexity classification to route the case for processing.

In the description above, for the purposes of explanation, numerous specific details are set forth in order to provide a thorough understanding of the described implementations. It may be apparent, however, to one skilled in the art that implementations may be practiced without some of these specific details. In other instances, well-known structures and devices are shown in block diagram form. There may be intermediate structure between illustrated components. The components described or illustrated herein may have additional inputs or outputs that are not illustrated or described.

Various implementations may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various implementations may be provided as a computer program product, which may include a computer-readable medium having stored thereon computer program instructions, which may be used to program a computer (or other electronic devices) for execution by one or more processors to perform a process according to certain implementations. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, implementations may also be downloaded as a computer program product, wherein the program may be transferred from a remote computer to a requesting computer. In some implementations, a non-transitory computer-readable storage medium has stored thereon data representing sequences of instructions that, when executed by a processor, cause the processor to perform certain operations.

Processes can be added to or deleted from any of the methods and information can be added or subtracted from any of the described messages without departing from the basic scope of the implementations herein. It may be apparent to those skilled in the art that many further modifications and adaptations can be made. The particular implementations are not provided to limit the concept but to illustrate it. The scope of the implementations is not to be determined by the specific examples provided above but by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic does not have to be included. If the specification or claim refers to “a” or “an” element, this does not mean there is only one of the described elements.

An implementation is an example or aspect. Reference in the specification to “an implementation,” “one implementation,” “some implementations,” or “other implementations” means that a particular feature, structure, or characteristic described in connection with the implementations is included in at least some implementations, but not necessarily all implementations. The various appearances of “an implementation,” “one implementation,” or “some implementations” are not necessarily all referring to the same implementations. It should be appreciated that in the foregoing description of example implementations, various features are sometimes grouped together in a single implementation, figure, or description thereof for the purpose of streamlining the disclosure and aiding in the understanding of one or more of the various novel aspects. This method of disclosure, however, is not to be interpreted as reflecting an intention that the claimed implementations utilize more features than are expressly recited in each claim. Rather, as the following claims reflect, novel aspects lie in less than all features of a single foregoing disclosed implementation. Thus, the claims are hereby expressly incorporated into this description, with each claim standing on its own as a separate implementation.

What is claimed is:

1. A method for comprising:
receiving a set of fields corresponding to a case;
inputting the set of fields to a hybrid model comprising a set of rules and a predictive model, wherein the predictive model comprises a predictive machine learning model trained using a historical set of cases that are specific to a technical domain of the case;
determining, via the hybrid model, a case complexity classification for the case based on analysis of the set of fields using the set of rules and the predictive model; and
utilizing the case complexity classification to route the case for processing.

2. The method of claim 1, wherein the analysis of the set of fields by the hybrid model comprises identifying a keyword match between the set of fields and the set of rules, and responsive to identifying the keyword match, applying an associated rule of the set of rules to generate the case complexity classification for the case.

3. The method of claim 2, wherein the keyword match comprises a match of at least one of an error code, an event signature, or a text string.

4. The method of claim 2, wherein responsive to failing to identify the keyword match, applying the predictive model to the set of fields.

5. The method of claim 4, wherein applying the predictive model comprises:
vectorizing the set of fields;
providing the vectorized set of fields as input for the predictive model; and
outputting, in response to the input of the vectorized set of fields, the case complexity classification for the case.

6. The method of claim 1, wherein the predictive model comprises a support vector machine (SVM) with linear kernel and 12 regularization.

7. The method of claim 1, wherein the historical set of cases are each labelled with a case complexity by a domain expert.

8. The method of claim 1, wherein the set of fields comprise at least a subject field, an issue text field, or a severity field.

9. The method of claim 1, wherein the case is managed by a case management system in a technical support environment.

10. The method of claim 1, wherein the case complexity classification is to indicate a level of difficulty in resolving a problem of the case.

11. The method of claim 1, wherein the set of rules and the predictive model are based on data provided in one or more languages.

12. A non-transitory machine-readable storage medium encoded with instructions that, when executed by a hardware processor, cause the hardware processor to:
receive a set of fields corresponding to a case;
input the set of fields to a hybrid model comprising a set of rules and a predictive model, wherein the predictive model comprises a predictive machine learning model trained using a historical set of cases that are specific to a technical domain of the case;
determine, via the hybrid model, a case complexity classification for the case based on analysis of the set of fields using the set of rules and the predictive model; and
utilize the case complexity classification to route the case for processing.

13. The non-transitory machine-readable storage medium of claim 12, wherein the analysis of the set of fields by the hybrid model comprises identifying a keyword match between the set of fields and the set of rules, and responsive to identifying the keyword match, applying an associated rule of the set of rules to generate the case complexity classification for the case.

14. The non-transitory machine-readable storage medium of claim 13, further comprising instructions to respond to failing to identify the keyword match by applying the predictive model to the set of fields, and wherein applying the predictive model comprises:
vectorizing the set of fields;
providing the vectorized set of fields as input for the predictive model; and
outputting, in response to the input of the vectorized set of fields, the case complexity classification for the case.

15. The non-transitory machine-readable storage medium of claim 12, wherein the predictive model comprises a support vector machine (SVM) with linear kernel and 12 regularization.

16. An apparatus comprising:
a processor; and
a machine readable storage medium storing instructions for a case complexity classifier that, when executed by the processor, cause the processor to:
receive a set of fields corresponding to a case;
input the set of fields to a hybrid model comprising a set of rules and a predictive model, wherein the predictive model comprises a predictive machine learning model trained using a historical set of cases that are specific to a technical domain of the case; and
determine, via the hybrid model, a case complexity classification for the case based on analysis of the set of fields using the set of rules and the predictive model;
wherein the case complexity classification is utilized to route the case for processing.

17. The apparatus of claim 16, wherein the analysis of the set of fields by the hybrid model comprises identifying a keyword match between the set of fields and the set of rules, and responsive to identifying the keyword match, applying an associated rule of the set of rules to generate the case complexity classification for the case.

18. The apparatus of claim 17, wherein the instructions further cause the processor to respond to failing to identify the keyword match by applying the predictive model to the set of fields.

19. The apparatus of claim 18, wherein applying the predictive model comprises:
vectorizing the set of fields;
providing the vectorized set of fields as input for the predictive model; and
outputting, in response to the input of the vectorized set of fields, the case complexity classification for the case.

20. The apparatus of claim 16, wherein the predictive model comprises a support vector machine (SVM) with linear kernel and 12 regularization.
